(19) United States
(12) Patent Application Publication
(10) Pub. No.: US 2003/0078791 A1
(43) Pub. Date: Apr. 24, 2003

(54) Method and system for increasing the participation of contributors to a charity or other non-profit

(76) Inventor: Brian N. Tufte, Eden Prairie, MN (US)

Correspondence Address: Brian N. Tufte, CROMPTON, SEAGER & TUFTE, LLC, Suite 895, 331 Second Avenue South, Minneapolis, MN, 55401-2246, US

(21) Appl. No.: 10/027,829

(22) Filed: Oct. 19, 2001

(51) Int. Cl. G06F 17/60

(52) U.S. Cl. 705/1

(57) ABSTRACT

Methods and systems are provided for increasing the participation of contributors of charities and/or other non-profits. In one illustrative embodiment, the contributors are allowed to track the location of goods and/or services assigned to their donation to an ultimate destination. In one example, the organization receives a donation from a contributor, and assigns the donation to a delivery lot of cash, goods and/or services. Once the delivery lot is assembled and shipped, the location of the delivery lot is obtained at one or more points in time, such as at selected ports of call, at the end of each shipping leg, or at any other intermediate or end point along the distribution path. The location information for the delivery lot is then passed on to the contributor.

### TECHNICAL FIELD OF THE INVENTION

The present invention relates to charities or other non-profits, and more particularly, to methods and systems for increasing the participation of contributors that provide donations to charities or other non-profits.

### BACKGROUND OF THE INVENTION

There are a large number of charities and other non-profits that provide needed resources to people or causes throughout the world. The effectiveness of these organizations is often dependent on the amount of resources that can be attracted, and eventually distributed. Many charities and other non-profits must spend a portion of their collected resources to attract additional resources, which reduces the efficiency of the charity and other non-profits. Since the various organizations must often compete for a limited number of resources, a balance must be struck between spending collected resources to attract more resources, and distributing resources to the people or causes supported by the charity and other non-profits.

Most charities and other non-profits accept donations in a wide variety of ways. For example, charities and other non-profits often accept donations by mail, through employer sponsored programs, over the phone, and more recently, over the Internet. Regardless of the collection method, contributors often simply provide a check or other resource to the charity or other non-profit, and then forget about the contribution. One reason for this is that the charities and other non-profits do not communicate to the contributors how their particular donation is actually used. That is, the contributors often do not see or feel the impact that their donations have on the beneficiaries of the donation. It is believed that this disconnect between the contributor and the impact made by the donation of the contributor limits the participation, and thus the interest and generosity of the contributor.

### SUMMARY OF THE INVENTION

The present invention provides methods and systems for increasing the participation of contributors of charities and other non-profits. By increasing the participation of the contributors, it is believed that the contributors will make more donations to the charities and other non-profits. In addition, by providing increased participation, it may be easier to attract contributors to a particular charity or other non-profit, which may help the charity or other non-profit gain a greater market share of the limited charitable donations contributed each year.

In one illustrative embodiment, the participation of contributors is increased by allowing the contributors to track their donations, or goods and/or services assigned to their donations, to an ultimate destination. In one example, the organization receives a donation from a contributor. The organization assigns the donation to a delivery lot of cash, goods and/or services. Then, the location of the delivery lot is obtained at one or more points in time, such as at selected ports of call, at the end of each shipping leg, or at any other intermediate or end point along the distribution path. The location information of the delivery lot is then provided to the contributor.

In one illustrative embodiment, the donation is received via the Internet. Information such as the contributor's name, payment information, and donation preferences may be received through dialog boxes on a charity's or other non-profit's web site. Alternatively, or in addition, the donation information may be received via an email message from the contributor, via the phone, via mail or any other method. In any case, each donation may be entered into a database and assigned a unique donation ID. In some embodiments, the unique donation ID may be provided to the contributor for later reference.

Once the donation is received, the organization may assign the donation to a delivery lot of cash, goods and/or services. This may be accomplished by, for example, making a resource request to the database. The database may accumulate donations until the resource request is met. The donations may be accumulated using an algorithm such as First-In-First-Out (FIFO), Last-In-Last-Out (LIFO), or any other suitable algorithm or method. In some cases, donations totaling more that the resource request may be assigned to a delivery lot to compensate for the overhead of the organization. The donations that have been accumulated to meet the resource request may then be updated to include a pointer or other reference to the assigned delivery lot.

Once the delivery lot is shipped, the location of the delivery lot may be obtained along the distribution path, preferably at one or more points in time. The contributors may be notified of the location of the delivery lot, preferably as it traverses the distribution path to an ultimate destination. The contributors may also be provided with information such as the contents of the delivery lot, the ultimate destination of the delivery lot, information relating to distribution path, and/or any other information that may be of interest to the contributors.

In one embodiment, each contributor may obtain information about his/her assigned delivery lot via the charity's or other non-profit's web site. In this embodiment, each contributor may enter his or her assigned unique donation ID on the charity's or other non-profit's web site. The web site may then display the location and/or other information that relates to the delivery lot. Alternatively, the contributor may log into the charity's or other non-profits web site through a log in procedure. Once logged in, all or some of the unique donation IDs associated with the contributor may be displayed. When one of the unique donation IDs is selected, the information related to the assigned delivery lot may be displayed. These are just a few examples of how information may be delivered to each contributor via the charity's or other non-profits web site.

Alternatively, or in addition, the information may be provided to the contributors via email. For example, the location information may be automatically sent to the contributor each time a new location of the delivery lot is obtained. Alternatively, or in addition, the location information may be provided to the contributors via mail, phone, fax or any other suitable method.

It is contemplated that one or more of contributors may be an organization. When so provided, it is contemplated that the unique donation ID associated with the organization's donation may be provided to the members of the organization. With the unique donation ID, each member may obtain information relating to the delivery lot that corresponds to the organizations donation. Alternatively, or in addition, each member of the organization may be given a unique donation ID, and the portion of the organization's donation attributed to each member may be assigned to a delivery lot. Each member may then track his or her portion of the organizations donation, as described above.

It is also contemplated that some personalized information may be provided to each contributor to further show the impact of his or her donations. This information may include, for example, total donations made by the contributor this year, total donations year over year, number and/or types of goods and services purchased and delivered as a result of the contributors donations, number of people serviced as a result of the contributors donations, number of meals delivered as a result of the contributors donations, and/or any other information that may help the contributor understand the impact that his or her donations are having on the beneficiaries of the charity or other non-profit.

### BRIEF DESCRIPTION OF THE DRAWINGS

Other objects of the present invention and many of the attendant advantages of the present invention will be readily appreciated as the same becomes better understood by reference to the following detailed description when considered in connection with the accompanying drawings, in which like reference numerals designate like parts throughout the figures thereof and wherein:

FIG. 1 is an illustrative web page that may be used for accepting donations from one or more contributors of a charity or other non-profit;

FIG. 2 is an illustrative web page that may be used for confirming the donation information received via the web page of FIG. 1, as well as for displaying an assigned donation ID;

FIG. 3 is an illustrative web page that may be used for receiving the assigned donation ID from the contributor, as well as for displaying information related to the delivery lot that corresponds to the received donation ID;

FIG. 4 is an illustrative web page that may be displayed after a contributor has logged into a charity's web site;

FIG. 5 is a block diagram of an illustrative system for increasing the participation of contributors that provide donations to charities or other non-profits;

FIGS. 6A-6B show an illustrative database that may be maintained for increasing the participation of contributors that provide donations to charities or other non-profits;

FIG. 7 is a flow diagram showing an illustrative method in accordance with the present invention;

FIG. 8 is a flow diagram showing another illustrative method in accordance with the present invention;

FIG. 9 is another illustrative web page that may be used for accepting donations from one or more contributors of a charity or other non-profit; and

FIG. 10 is a schematic diagram showing an illustrative flow of cash, goods and/or services between organizations.

### DETAILED DESCRIPTION OF THE PREFERRED EMBODIMENTS

The present invention provides methods and systems for increasing the participation of contributors of charities and other non-profits. In one illustrative embodiment, the participation of a contributor is increased by allowing the contributor to track his or her donation, or goods and/or services assigned to his or her donation, to an ultimate destination. In one example, the organization receives a donation from a contributor. The organization then assigns the donation to a delivery lot of cash, goods and/or services. Once the delivery lot is shipped, the location of the delivery lot is obtained at one or more points in time, such as at selected ports of call, at the end of each shipping leg, or at any other intermediate or end point along the distribution path. The location information of the delivery lot may then be provided to the contributor.

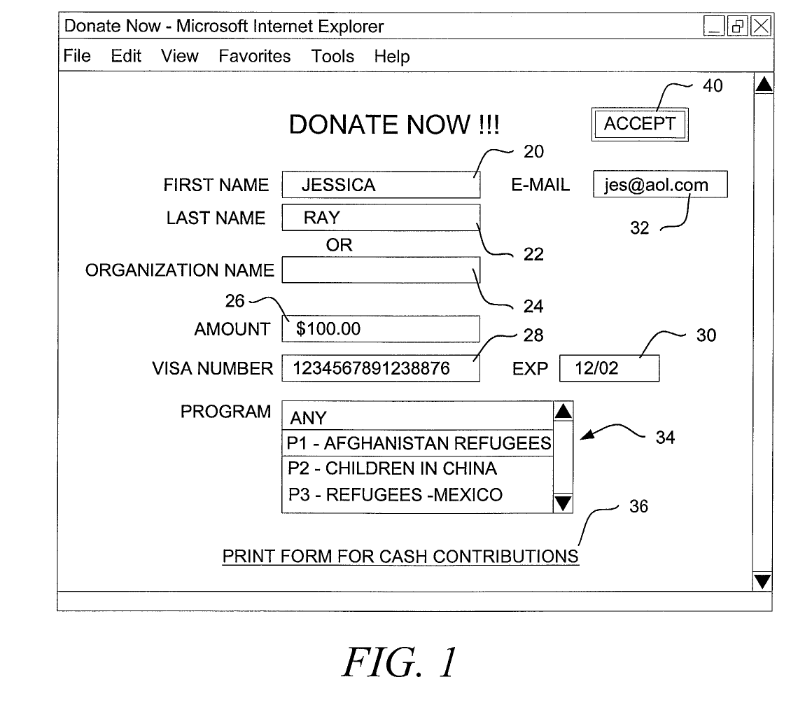

As shown in FIG. 1, the donation may be received via the Internet. FIG. 1 is an illustrative web page that may be used for accepting donations from one or more contributors of a charity or other non-profit. The illustrative web page has a number of dialog boxes for accepting information from the contributor. For example, the illustrative web page has dialog boxes 20 and 22 for receiving the contributor's first and last name, respectively. Dialog box 24 is provided for accepting donations on behalf of an organization, such as a company. Dialog box 26 is provided for receiving the amount of the donation. Dialog boxes 28 and 30 are provided for receiving a VISA card number and card expiration date, respectively. Dialog box 32 is provided for receiving the contributors e-mail address. Finally, a drop down menu 34 is provided to allow the contributor to direct his or her donation to a particular program, when appropriate. Finally, a hyperlink 36 is provided to provide a printable form that may be used to make a donation by cash or check.

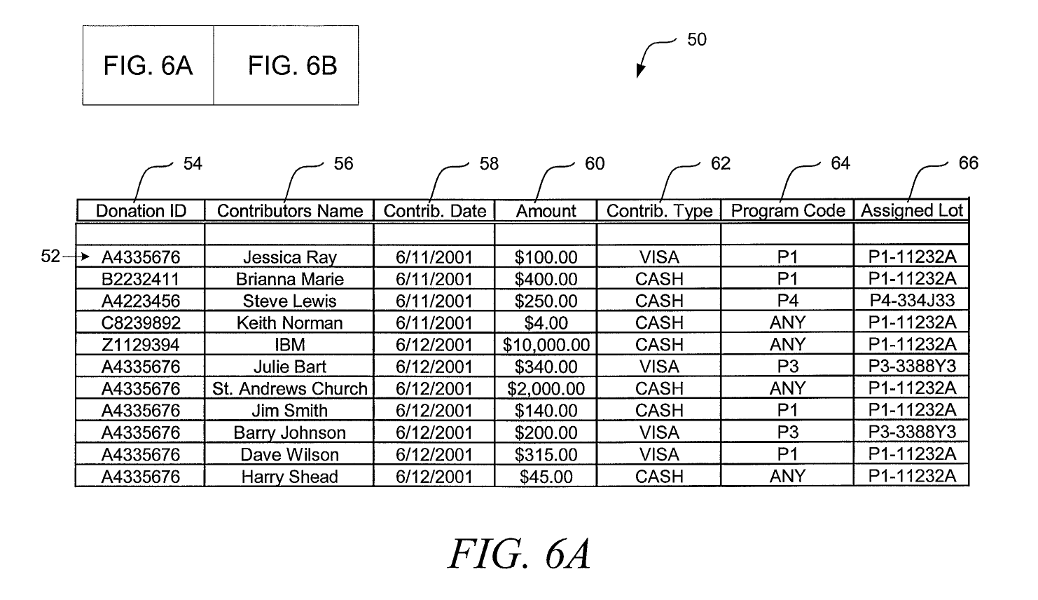

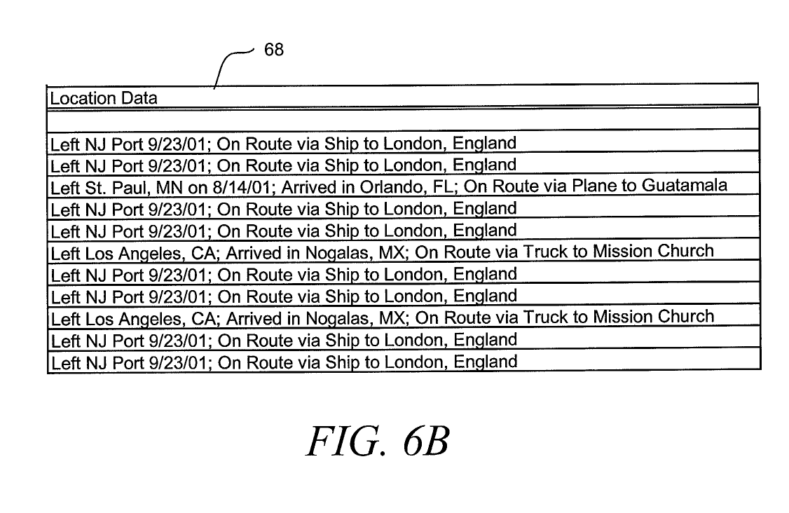

Once the contributor enters the appropriate information, the contributor may click on the “Accept” button 40. Once the “Accept” button 40 is selected, the information provided by the contributor is preferably stored in a database, such as database 50 shown in FIGS. 6A-6B. While the illustrative web page shown in FIG. 1 allows contributors to make donations via the Internet, it is contemplated that the donations may be received via email, phone, mail, fax, or any other method. In any case, each donation is preferably entered into a database, such as database 50 of FIG. 6A, and assigned a unique donation ID.

Referring to FIG. 6A, the information entered in FIG. 1 is shown in a database entry (row) 52. Database entry 52 has a number of columns, including a donation ID column 54, a contributors name column 56, a contribution date column 58, a donation amount column 60, a contribution type column 62, a program code column 64, an assigned delivery lot column 66, and a location information column 68 (see FIG. 6B). When the contributor selects the “Accept” button 40 in FIG. 1, a unique donation ID is generated and assigned to the donation and entered into the donation ID column 54. The contributors name, contribution date, donation amount, contribution type and program code are all entered into the respective columns in database entry 52 of database 50. The contributors e-mail address may also be provided into a contributors e-mail column in database entry 52 of database 50, if desired.

Once entered, and in some embodiments, selected information such as the contributor's credit card number, is sent to a check/credit card clearing house. The check/credit card clearing house may report back whether the donation can be accepted. Selected information from the report provided by the check/credit card clearing house may also be stored in database entry 52 of database 50, if desired.

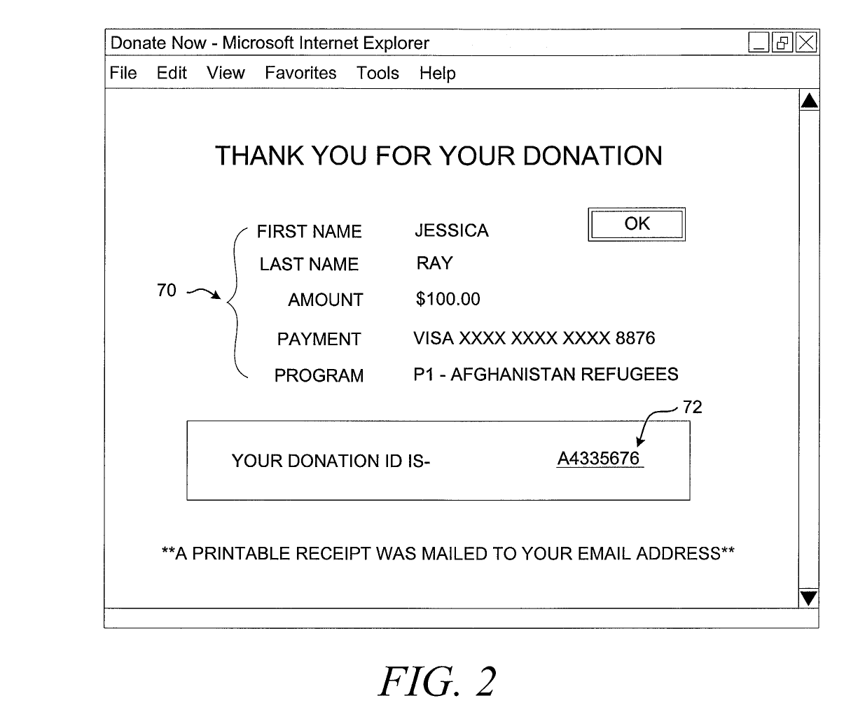

The illustrative web page shown in FIG. 2 may be displayed after the contributor selects the “Accept” button 40 of FIG. 1. As can be seen, the illustrative web page of FIG. 2 displays confirmation information 70, as well as the unique donation ID assigned to the particular donation, as shown at 72. Alternatively, or in addition, the unique donation ID may also be mailed to the contributors e-mail address, if desired. The unique donation ID may be retrieved from the donation ID column 54 of database entry 52, as shown in FIG. 6A. In one embodiment, a printable receipt may be mailed to the contributors e-mail address, as shown at 74. The contributors e-mail address may have been previously received via the e-mail address dialog box 32 shown in FIG. 1. The printable receipt may be useful for tax purposes by the contributor.

Once the donation is received and processed, the charity or non-profit may assign the donation to a delivery lot of cash, goods and/or services. This may be accomplished by, for example, making a resource request to the database 50. The database 50 may accumulate donations until the resource request is met. The donations may be accumulated using an algorithm such as First-In-First-Out (FIFO), Last-In-Last-Out (LIFO), or any other suitable algorithm or method. In some embodiments, the resource request may correspond to a particular program of the charity, and only those donations that correspond to a particular program are accumulated. For example, if the organization makes a resource request for $100,000 for a delivery lot for program P1, the most dated donations that correspond to program P1 may be accumulated (FIFO) until $100,000 in donations is reached. These donations may then be assigned to a delivery lot of cash, goods and/or services. In some cases, donations totaling more that the resource request may be assigned to a delivery lot to compensate for the overhead of the organization.

Each donation in the database 50 may then be updated to include a pointer or reference to the assigned delivery lot. Referring to FIG. 6A, database entry 52 indicates that the assigned delivery lot is “P1-11232A”. The “P1” indicates that the delivery lot is for program P1, which in the illustrative embodiment, was selected by the contributor in dialog box 34 of FIG. 1.

It is contemplated that each delivery lot may include any combination of cash, goods and/or services. The goods may include, for example, food, medicines, cloths, or any other type of goods. The services may include legal services, medical services, or any other type of services.

Once the delivery lot is assembled and shipped, the location of the delivery lot is obtained along the distribution path, preferably at one or more points in time. For example, the location of the delivery lot may be obtained at selected ports of call, at the end of each shipping leg, or at any other intermediate or end point along the distribution path. In one embodiment, bar code scanner may be used to record the location of the delivery lot as it travels along the distribution path, although this is not required. The location information for each delivery lot may be entered into the database 50, such as in a location information column 68 of FIG. 6B. Alternatively, the location information may be stored in a separate database table, and the delivery lot pointer (e.g. “P1-11232A”) of each database entry may be used to look up the corresponding location information, if desired.

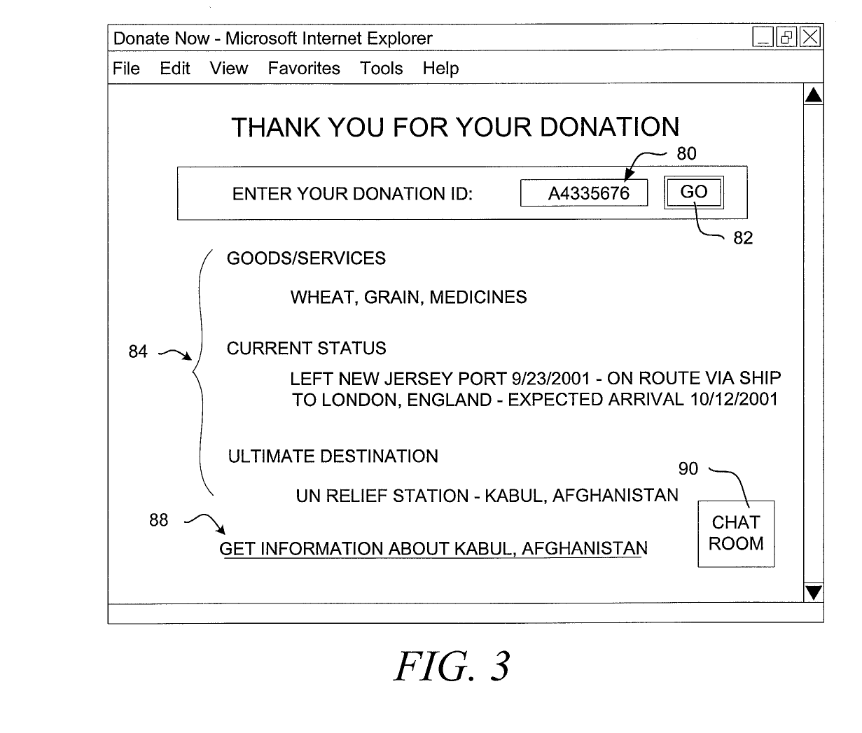

FIG. 3 is an illustrative web page that may be used for receiving an assigned donation ID from a contributor, and for displaying information related to the corresponding delivery lot. In the illustrative web page, a dialog box 80 is provided for receiving a donation ID, which preferably was previously provided to the contributor as described above. Once entered, the contributor may click the go button 82. The go button 82 provides a request to display information related to the delivery lot that corresponds to the donation ID.

In the illustrative embodiment, the information is displayed in section 84. The information may include, for example, the types of goods or services included in the delivery lot, the current and/or past location information of the delivery lot, information relating to the distribution path of the delivery lot, the ultimate destination of the delivery lot, and/or other information believed to be interesting to the contributor. A hyperlink 88 may also be provided that may provide information about the ultimate destination of the delivery lot. This information may include pictures, reports, commentary, or any other information. In some embodiments, a chat room 90 may be provided to allow those contributors that have donations assigned to a particular delivery lot to communicate with each other, and/or aid relief workers and/or beneficiaries of the delivery lot.

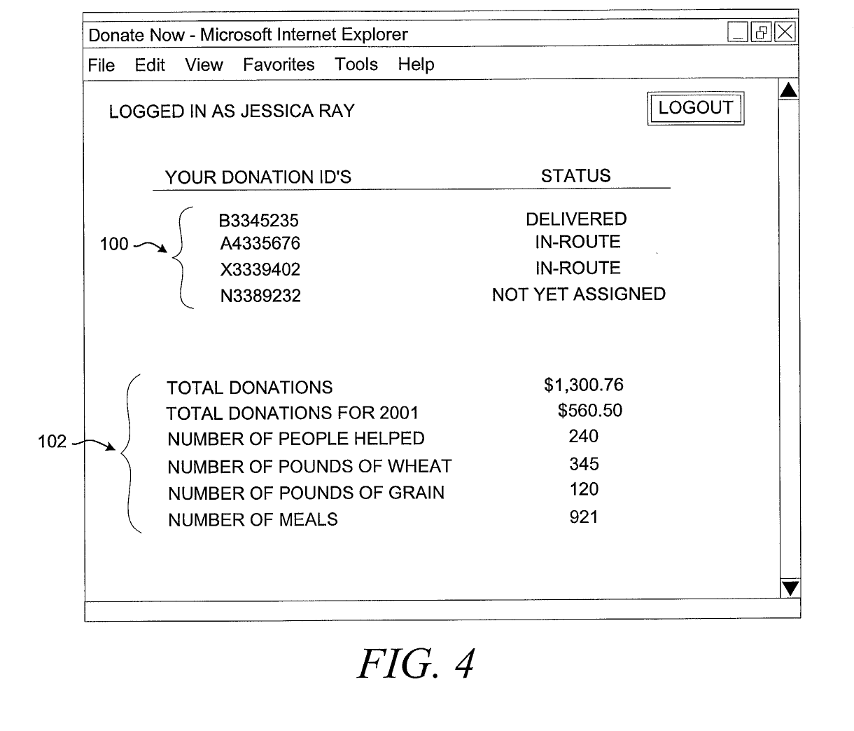

Rather than providing a dialog box 80 for receiving a donation ID, it is contemplated that a contributor may log onto the charity's or other non-profit's web site through a conventional log in procedure. FIG. 4 is an illustrative web page that may be displayed after a contributor has logged into a charity's web site. Once logged in, all or some of the unique donation IDs associated with the contributor may be displayed, as shown at 100. The status of each donation may also be displayed. For example, the status column for the donation having the donation ID of “B3345235” indicates that that corresponding delivery lot has already been delivered. Likewise, the status column for the donation having the donation ID of “A4335676” indicates that that corresponding delivery lot is currently in-route, and the status column for the donation having the donation ID of “N3389232” indicates that that donation has not yet been assigned to a delivery lot. When one of the unique donation IDs is selected, such as donation ID “A4335676”, information related to the assigned delivery lot may be displayed.

It is also contemplated that some personalized information 102 may be provided to each contributor to further show the impact of their donations. This information may include, for example, total donations made by the contributor this year, total donations year over year, number and/or types of goods and services purchased and delivered as a result of the contributors donations, number of people helped as a result of the contributors donations, number of meals delivered as a result of the contributors donations, and/or any other information that may help the contributor understand the impact that his or her donations are having on the beneficiaries of the charity or other non-profit. These are just a few examples of how information may be delivered to each contributor via the charity's or other non-profits web site.

Alternatively, or in addition, the above information may be provided to the contributors via email. For example, the location information may be automatically or manually sent to the contributors via email each time a new location of the delivery lot is obtained. Alternatively, or in addition, the location information may be provided to the contributors via mail, phone, fax or any other suitable method.

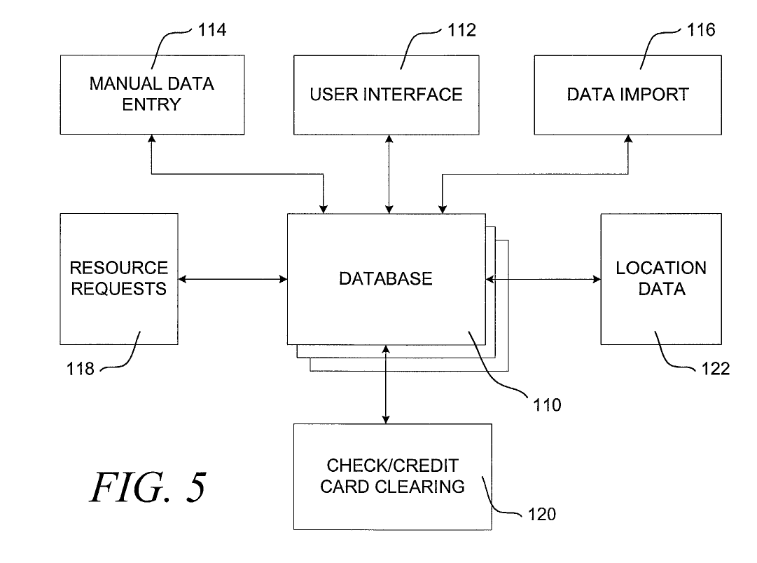

FIG. 5 is a block diagram of an illustrative system for increasing the participation of contributors that provide donations to charities or other non-profits. The illustrative system includes one or more databases 110, a user interface block 112, a manual data entry block 114, a data import block 116, a resource request block 118, a check/credit card processing block 120 and a location data block 122. The database 110 may be similar to the database shown in FIGS. 6A-6B. However, it is contemplated that the database 110 may include more fields (or columns) than are shown in the illustrative database of FIGS. 6A-6B. For example, database 110 may include an e-mail address field, a credit card number field, an ultimate destination field, as well as many other fields, as desired. The database 110 is preferably a relational database such as a Microsoft Access®, Microsoft SQL Server 2000®, Oracle 9i®, etc., but may be any privately created or commercially available database. The database 110 is preferably running on a server that is connected to the Internet.

The database may be populated in any number of ways. The user interface block 112 may display a web page, such as the web page shown in FIG. 1. The user interface block 112 may accept information from contributors, and provide the information to the database 110. For those donations that are received by, for example, mail, fax or phone, manual data entry block 114 may be used to provide the necessary data into the database 110. That is, using the manual data entry block 114, the charity or other non-profit may manually enter information into the database 110 for selected donations.

The data import block 116 may import data from one or more other databases. For example, a charity or other non-profit may already have one or more databases that store information about its' contributors. This information may be transferred into the database 110 using the data import block 116, if desired. Alternatively, or in addition, a charity or non-profit may have access to one or more other databases which may be transferred into database 110.

When donations are received, selected information may be sent to a check/credit card clearing house via check/credit card clearing block 120. The check/credit card clearing block 120 may report back to the database 110 whether the donation can be accepted. Selected information from the report from the check/credit card clearing block 120 may be stored in database 110, if desired. In some embodiments, the check/credit card clearing block 120 may not process some donations, such as those transferred from another database through the data import block 116. In other embodiments, all donations that are paid for with a check or credit card are processed by the check/credit card clearing block 120.

After the donations have cleared, the system may assign each donation to a delivery lot of cash, goods and/or services. This may be accomplished by, for example, making a resource request to the database 110 via resource request block 118. The database 110 (or other program that accesses and/or controls the database 110) may accumulate cleared donations until the resource request is met. The donations may be accumulated using an algorithm such as First-In-First-Out (FIFO), Last-In-Last-Out (LIFO), or any other suitable algorithm. The accumulated donations may then be assigned to a delivery lot of cash, goods and/or services. In some cases, donations totaling more that the resource request may be assigned to a delivery lot to compensate for the overhead of the organization. Accumulated donation in the database 110 may then be updated to include a pointer or other reference to the assigned delivery lot, if desired.

Once the delivery lot is assembled and shipped, the location of the delivery lot may be obtained along the distribution path, preferably at one or more points in time. The location data block 122 may provide the location information to the database 110. In some embodiments, the location information may be transferred electronically to the database 110, sometimes across the Internet. It is contemplated that the location information may stored in each database entry, or may be stored in a separate database table, and a delivery lot pointer associated with each database entry may be used to look up the corresponding location information.

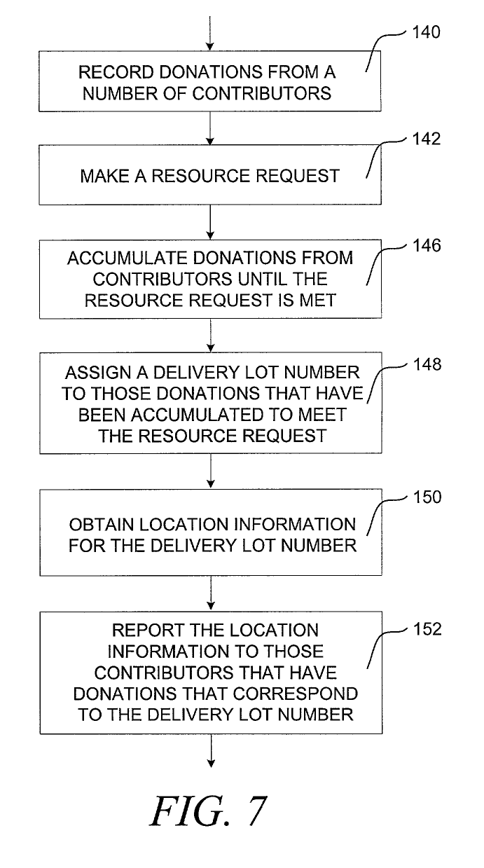

FIG. 7 is a flow diagram showing an illustrative method in accordance with the present invention. The method is entered at step 140, wherein donations from a number of contributors are obtained and recorded. Next, a resource request is made, as shown at step 142. At step 146, the recorded donations are accumulated until the resource request is met. Step 148 assigns a delivery lot number to those donations that have been accumulated to meet the resource request. Step 150 obtains location information for the delivery lot, and step 152 reports the location information to those contributors that have donations that correspond to the delivery lot number.

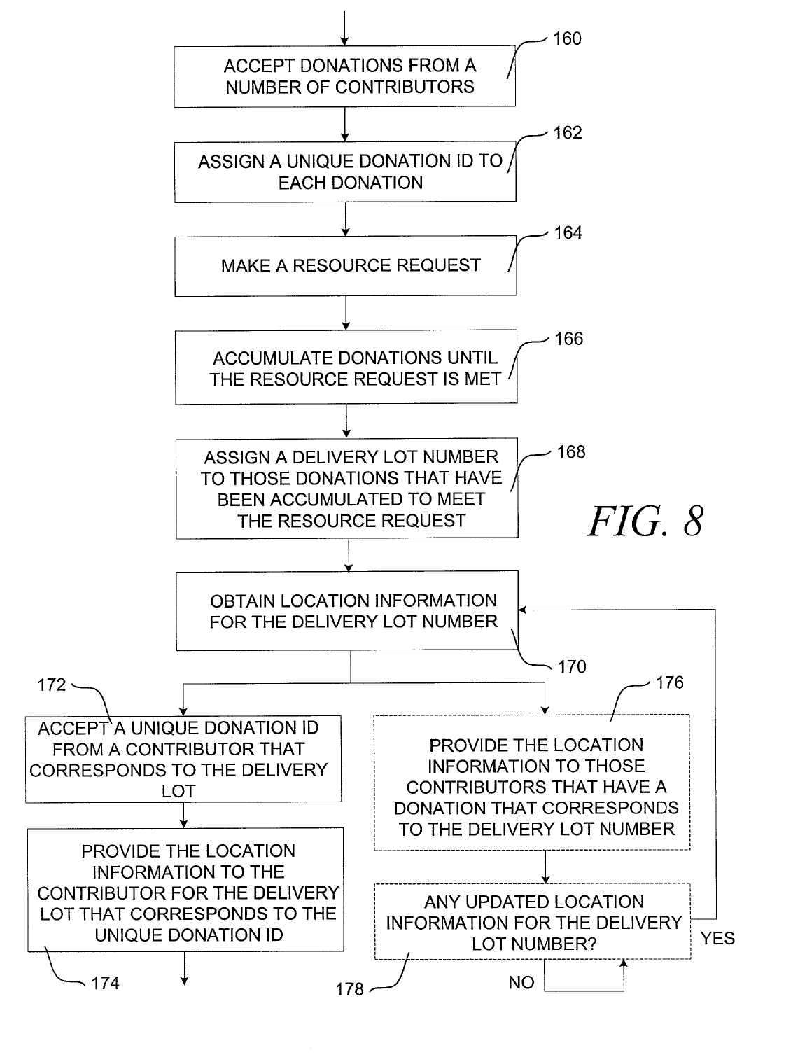

FIG. 8 is a flow diagram showing another illustrative method in accordance with the present invention. Step 160 accepts one or more donations from a number of contributors. A unique donation ID is assigned to each donation, as shown at step 162. A resource request is then made, as shown at step 164. Step 166 accumulates donations until the resource request is met. Step 168 assigns a delivery lot number to those donations that have been accumulated to meet the resource request. Step 170 obtains location information for the delivery lot.

In one illustrative embodiment, the unique donation ID is accepted from a contributor, as shown at step 172. Step 174 then provides the location information to the contributor for the delivery lot that corresponds to the unique donation ID. In this embodiment, each time the contributor submits the unique donation ID, the current location of the delivery lot is displayed.

In another illustrative embodiment, and as shown in dashed lines, the location information may be automatically provided to those contributors that have a donation that corresponds to the delivery lot number, as shown at step 176. Step 178 determines if there is any updated location for the delivery lot number. If no updated information is available, step 178 is repeated. If updated information becomes available, control is passed back to step 170, wherein updated location information for the delivery lot is obtained. Step 176 then provides the updated location information to those contributors that have a donation that corresponds to the delivery lot number. In this embodiment, the location information may be automatically sent to the contributors each time updated location is obtained for the delivery lot.

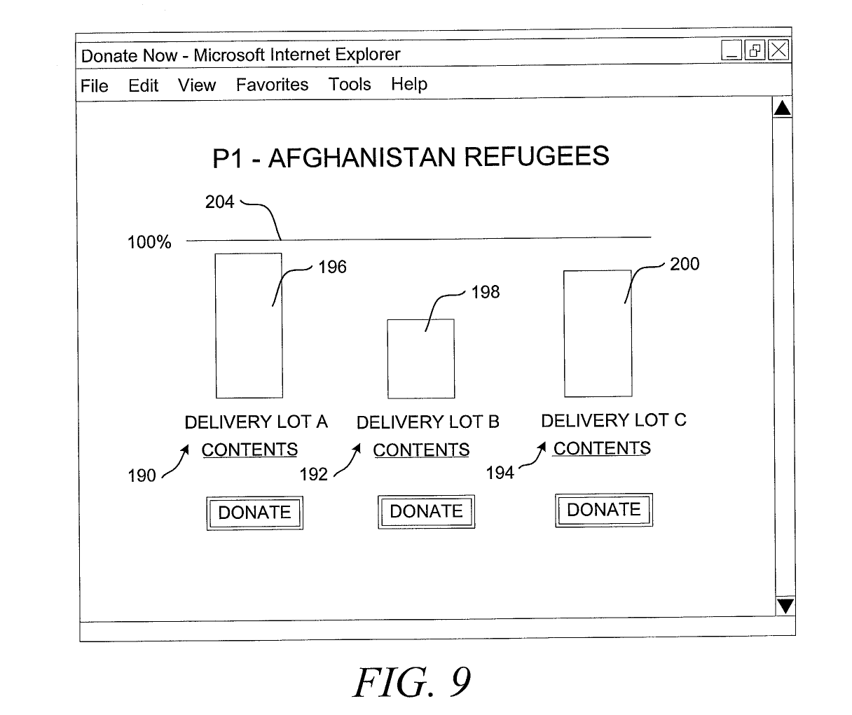

FIG. 9 is another illustrative web page that may be used for accepting donations from one or more contributors of a charity or other non-profit. In this embodiment, a number of available delivery lots that need to be funding are displayed. In the illustrative web page, delivery lot A 190, delivery lot B 192 and delivery lot C 194 are shown. The contents of each delivery lot 190, 192 and 194 may be viewed by simply clicking on the “Contents” hyperlinks shown directly below each delivery lot.

In the illustrative embodiment, a bar chart is displayed that indicates the level that each delivery lot is currently funded by donations. For example, delivery lot A 190 includes bar 196, delivery lot B 192 includes bar 198, and delivery lot C 194 includes bar 200. To donate to a particular delivery lot, the contributor may simply click on the donate button located below the desired delivery lot. When one of the donate buttons is selected, a web page similar to that shown in FIG. 1 may be displayed to accept information from the contributor. The particular delivery lot selected may also be displayed.

It is contemplated that when one of the delivery lots becomes 100% funded, as indicated by line 204, the delivery lot may be assembled and shipped. The contributors that contributed to the delivery lot may then be provided with location and/or other information related to the delivery lot, as described above.

In addition, it is contemplated that one or more of contributors may be an organization. When so provided, it is contemplated that the unique donation ID associated with the organization's donation may be provided to the members of the organization. With the unique donation ID, each member may obtain information relating to the delivery lot that corresponds to the organizations donation. Alternatively, or in addition, each member of the organization may be given a unique donation ID, and the portion of the organization's donation attributed to each member may be assigned to a delivery lot. Each member may then track his or her portion of the organizations donation, as described above.

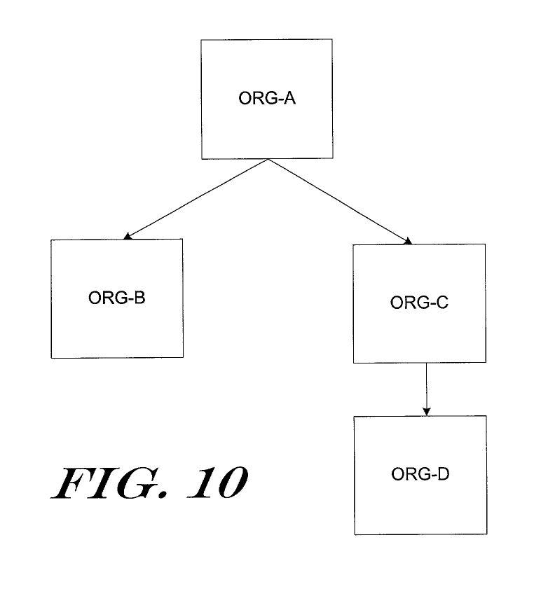

Rather than having a single charity or non-profit receive one or more donations from contributors, assign the donations to delivery lots of cash, goods and/or services, obtain the location of the delivery lots at one or more points in time, and provide the location of the delivery lots to the contributors, it is contemplated that two or more organizations may be involved. FIG. 10 is a schematic diagram showing an illustrative flow of cash, goods and/or services between two or more organizations. In the illustrative diagram, cash, goods and/or services are collected or received by Organization-A, which may be a charity or other non-profit. Organization-A may deliver some or all of the cash, goods and/or services to Organization-B and Organization-C, as shown. Organization-B and Organization-C may be other charities or non-profits, or in some cases, for-profit companies if desired. Some for-profit companies may be involved, particularly during the delivery of the delivery lots to their ultimate destination (e.g. shipping companies, etc.). Organization-C may deliver some or all of the cash, goods and/or services received from Organization-A to Organization-D, if desired. Organization-D may be another charity or other non-profit, or in some cases, a for profit company.

At any stage, any one of the organizations shown may: assign the donation to a delivery lot of cash, goods and/or services; obtain the location of the delivery lot at one or more points in time; and/or provide the location of the delivery lot to the contributor. In some cases, one organization may directly or indirectly receive donations from another organization and assign the donations to delivery lots of cash, goods and/or services. The same organization, or another organization, may obtain the location of the delivery lot at one or more point in time. Yet still another organization may provide the location of the delivery lot to the contributor, if desired. Preferably, the location information is eventually provided to the organization that provides the location information to the appropriate contributors.

Having thus described the preferred embodiments of the present invention, those of skill in the art will readily appreciate that the teachings found herein may be applied to yet other embodiments within the scope of the claims hereto attached.

What is claimed is:

1. A method for increasing the participation of contributors that provide donations to an organization, the method comprising the steps of:
receiving either directly or indirectly a donation from a contributor;
assigning the donation to a delivery lot of cash, goods and/or services;
obtaining the location of the delivery lot at one or more points in time; and
providing the location of the delivery lot to the contributor.

2. A method according to claim 1 wherein the receiving step includes receiving information related to the donation via the Internet.

3. A method according to claim 2 wherein the information includes a contributor's name.

4. A method according to claim 2 wherein the information includes a contributor's payment information.

5. A method according to claim 2 wherein the information includes a donation preference.

6. A method according to claim 1 wherein the receiving step includes receiving information related to the donation via the phone.

7. A method according to claim 1 wherein the receiving step includes receiving information related to the donation via email.

8. A method according to claim 1 wherein the cash, goods and/or services includes food.

9. A method according to claim 1 wherein the cash, goods and/or services includes medicine.

10. A method according to claim 1 wherein the cash, goods and/or services includes cash.

11. A method according to claim 1 wherein the location of the delivery lot is provided in response to a request from the contributor.

12. A method according to claim 1 wherein the location of the delivery lot is provided via a web site that is accessible by the contributor.

13. A method according to claim 1 wherein the location of the delivery lot is automatically provided to the contributor at the one or more points in time.

14. A method according to claim 13 wherein the location of the delivery lot is provided to the contributor via e-mail.

15. A method according to claim 1 wherein the delivery lot includes one type of cash, goods and/or services.

16. A method according to claim 1 wherein the delivery lot includes two or more types of cash, goods and/or services.

17. A method according to claim 1 wherein each donation is assigned to a unique delivery lot.

18. A method according to claim 1 wherein two or more donations are assigned to a common delivery lot.

19. A method according to claim 1 wherein the obtaining step includes obtaining the location of each delivery lot at two or more points in time, each corresponding to a different location.

20. A method for increasing the participation of contributors that provide donations to an organization, the method comprising the steps of:
receiving either directly or indirectly two or more donations from two or more contributors;
assigning each donation to a delivery lot of cash, goods and/or services;
obtaining the location of each delivery lot at one or more points in time; and
providing the location of a delivery lot to one or more contributors, each contributor receiving the location of the delivery lots that correspond to the contributor's donations.

21. A method according to claim 20 wherein each donation is assigned a unique ID, and each contributor provides or selects the unique ID to receive the location of the corresponding delivery lot.

22. A method according to claim 21 wherein each contributor provides or selects the unique ID via a web site.

23. A method according to claim 20 wherein the obtaining step includes obtaining the location of each delivery lot at two or more points in time, each corresponding to a different location.

24. A system for increasing the participation of contributors that provide donations to an organization, the system comprising:
means for receiving either directly or indirectly a donation from a contributor;
means for assigning the donation to a delivery lot of cash, goods and/or services;
means for obtaining the location of the delivery lot at one or more points in time; and
means for providing the location of the delivery lot to the contributor.

25. A method for increasing the participation of contributors that provide donations to an organization, the method comprising the steps of:
assigning selected donations to a common delivery lot for delivery to an ultimate destination; and
reporting information relating to the delivery of the delivery lot to contributors whose donations have been assigned to the delivery lot.

26. A method according to claim 25 wherein the contributors include individuals.

27. A method according to claim 25 wherein the contributors include organizations with organization members.

28. A method according to claim 25 wherein information relating to the delivery of the delivery lot is reported to one or more members of the contributing organizations.

29. A method according to claim 25 further comprising the step of:
providing a chat room so that the contributors that provided donations to a common delivery lot can communicate with each other.

30. A method for increasing the participation of contributors that provide donations to an organization, the method comprising the steps of:
displaying one or more delivery lots that need to be funding;
allowing contributors to select one or more of the available delivery lots, and provide a donation thereto; and
sending a funded delivery lot once the delivery lot is fully funded.

31. A method according to claim 30 further comprising the step of:
obtaining location information for the funded delivery lot after the funded delivery lot is sent; and
providing the location information to those contributors that provided donations to the funded delivery lot.

32. A method for increasing the participation of contributors that provide donations, wherein the donations are assigned to one or more delivery lots of cash, goods and/or services, the method comprising:
obtaining the location of the delivery lot at one or more points in time; and
providing the location of the delivery lot either directly or indirectly to the contributor.
